(19) United States
(12) Patent Application Publication
(10) Pub. No.: US 2011/0242652 A1
(43) Pub. Date: Oct. 6, 2011

(54) POLARIZING DEVICE FOR SELECTIVELY BLOCKING AND TRANSMITTING RADIATION AND METHOD MAKING SAME

(76) Inventor: Hassan Sahouani, Hastings, MN (US)

(21) Appl. No.: 13/132,355

(22) PCT Filed: Dec. 18, 2009
(86) PCT No.: PCT/US09/68618

§ 371 Date: Jun. 2, 2011

Related U.S. Application Data
(60) Provisional application No. 61/141,757, filed on Dec. 31, 2008.

(51) Int. Cl. G02B 27/28; B05D 5/06

(52) U.S. Cl. 359/486.02; 359/487.02; 359/486.01; 427/163.1

(57) ABSTRACT

An optical device (10) comprising two layers (12, 18), with each layer having a plurality of adjacent and substantially coplanar polarizing layer portions (14, 16), with any two adjacent ones of these polarizing layer portions having orthogonal polarization directions. These two layers are movable relative to one another such that each of the polarizing layer portions from one layer can substantially overlap at least two of the polarizing layer portions from the other layer, with one of these other polarizing layer portions having a substantially identical polarization direction (FIG. 2a) and the other having an orthogonal polarization direction (FIG. 26). In this way, radiation wavelengths passing through the two layers can be selectively blocked and transmitted therethrough by moving the two layers relative to one another.

The present invention relates to devices for blocking or allowing the transmission of radiation, in particular to devices for selectively blocking and transmitting radiation, and more particularly, to such devices for controlling the transmission of visible light, as well as methods of making such devices.

### BACKGROUND

There are various devices available that can control the degree of light transmission therethrough. Such devices are commonly referred to as light control devices or light valves. Some of the most common methods of making such light valve devices are based on the use of liquid crystal devices, photochromic dyes or electrochromic dyes. All of these type light valve devices can suffer from a number of shortcomings. For example, when the temperature of their environment changes, the speed at which the device can switch between degrees of light transmission can vary. Accordingly, there is a need for a new approach to controlling the transmission of light or light intensity that does not suffer from one or more of the shortcomings (e.g., sensitivity to temperature variations) exhibited by previous light control devices.

### SUMMARY OF THE INVENTION

In one aspect of the present invention, a device is provided that includes a first layer comprising at least one first layer portion adjacent at least one second layer portion. The first layer portion comprises a first guest host polarizer and the second layer portion comprising a second guest host polarizer. The first guest host polarizer comprises a first host matrix, and at least one or more first guest dyes disposed in the first host matrix and oriented so as to absorb a first band or range of radiation wavelengths (e.g., the band of visible light, red light, blue light, or some other color of light) having a first polarization state. In addition, the second guest host polarizer comprises a second host matrix and at least one or more second guest dyes disposed in the second host matrix and oriented to absorb a second band or range of radiation wavelengths (e.g., the band of visible light, red light, blue light, or some other color of light) having a second polarization state orthogonal to the first polarization state. Preferably, the first layer comprises a plurality of first and second layer portions disposed in an alternating manner along adjoining edges, with one first layer portion being disposed between any two adjacent second layer portions and one second layer portion being disposed between any two adjacent first layer portions. It is desirable for the first and second layer portions to be substantially coplanar for space efficiency considerations such as, for example, when the maintaining a minimized thickness for the device is desired.

To produce an optical device for selectively blocking (i.e., preventing the passage therethrough) and transmitting (i.e. allowing the passage therethrough) radiation having radiation wavelengths (e.g., visible light, infrared and ultraviolet radiation, etc.), a second layer is included that comprises at least one third layer portion adjacent at least one fourth layer portion. The third layer portion comprises a third guest host polarizer and the fourth layer portion comprises a fourth guest host polarizer. The third guest host polarizer comprises a third host matrix, and at least one or more third guest dyes disposed in the third host matrix and oriented so as to absorb a third band or range of radiation wavelengths (e.g., the band of visible light, red light, blue light, or some other color of light) having a third polarization state. In addition, the fourth guest host polarizer comprises a fourth host matrix and at least one or more fourth guest dyes disposed in the fourth host matrix and oriented to absorb a fourth band or range of radiation wavelengths (e.g., the band of visible light, red light, blue light, or some other color of light) having a fourth polarization state orthogonal to the third polarization state. The first layer and the second layer completely or at least substantially overlap one another and are preferably disposed substantially parallel to one another. In addition, at least one of the first layer and the second layer is moveable such that each layer portion of the first layer can completely or at least substantially overlap at least one third layer portion and at least one fourth layer portion of the second layer so as to selectively block and transmit radiation wavelengths.

In another aspect of the present invention, an optical device is provided that comprises a first substrate coated with at least one first polarizing stripe and at least one second polarizing stripe. Each polarizing stripe comprises at least one layer of polarizing material, with the stripe having a width and a length, where the length of the stripe is equal to or greater than the width. Each first polarizing stripe is disposed adjacent at least one second polarizing stripe. Preferably, each first polarizing stripe is disposed adjacent and substantially coplanar with at least one second polarizing stripe along adjoining edges. The first polarizing stripe blocks radiation wavelengths having a first polarization state, and the second polarizing stripe blocks radiation wavelengths have a second polarization state, where the first polarization state is orthogonal to the second polarization state.

To produce an optical device for selectively blocking (i.e., preventing the passage therethrough) and transmitting (i.e. allowing the passage therethrough) radiation having radiation wavelengths (e.g., visible light, infrared and ultraviolet radiation, etc.), a second substrate is provided that is coated with at least one third polarizing stripe and at least one fourth polarizing stripe. Each third polarizing stripe is disposed adjacent at least one fourth polarizing stripe. Preferably, each third polarizing stripe is disposed adjacent and substantially coplanar with at least one fourth polarizing stripe along adjoining edges. The third polarizing stripe blocks radiation wavelengths having the first polarization state, and the fourth polarizing stripe blocks radiation wavelengths have the second polarization state. The first substrate and the second substrate substantially overlap one another and are preferably disposed substantially parallel to one another. At least one of the substrates is moveable such that each polarizing stripe of the first substrate can completely or at least substantially overlap at least one third polarizing stripe and at least one fourth polarizing stripe of the second substrate so as to selectively block and transmit radiation wavelengths.

The first substrate preferably comprises a plurality of first polarizing stripes and a plurality of second polarizing stripes disposed in alternating positions along adjoining edges, with one of the first polarizing stripes being disposed between any two adjacent second polarizing stripes and one of the second polarizing stripes being disposed between any two adjacent first polarizing stripes. Likewise, the second substrate preferably comprises a plurality of third polarizing stripes and a plurality of fourth polarizing stripes disposed in alternating positions along adjoining edges, with one of the third polarizing stripes being disposed between any two adjacent fourth polarizing stripes and one of the fourth polarizing stripes being disposed between any two adjacent third polarizing stripes. It is desirable for each polarizing stripe to block substantially the same radiation wavelengths. In addition, each first polarizing stripe and each third polarizing stripe can comprise the same polarizing material. Likewise, each second polarizing stripe and each fourth polarizing stripe can comprise the same polarizing material. As with the preceeding embodiment, the present optical device can include a mechanism for moving at least one of the substrates relative to one another such that each of the polarizing stripes of the first substrate can be disposed to overlap at least one third polarizing stripe and at least one fourth polarizing stripe of the second substrate.

In an additional aspect of the present invention, an optical device is provided that comprises one layer having a plurality of adjacent and substantially coplanar polarizing layer portions, with any two adjacent ones of these polarizing layer portions having orthogonal polarization directions. In order to selectively block and transmit radiation wavelengths, the optical device further comprises another layer having a plurality of adjacent and substantially coplanar polarizing layer portions, with any two adjacent of these other polarizing layer portions having orthogonal polarization directions. These two layers are movable relative to one another such that each of the polarizing layer portions from one layer can completely or at least substantially overlap at least one of the polarizing layer portions from the other layer having a substantially identical polarization direction and at least one of the polarizing layer portions from the other layer having an orthogonal polarization direction. In this way, radiation wavelengths passing through the two layers can be selectively blocked and transmitted therethrough simply by moving the two layers relative to one another.

It can be desirable for the device to include a first substrate and a second substrate. The first substrate comprises a first surface coated with the one layer, and the second substrate comprises a second surface coated with the other layer.

It is desirable for the device to also include a mechanism for moving at least one of the first substrate and the second substrate relative to one another such that each of the first polarizing layer portions can completely or at least substantially overlap at least one second polarizing layer portion having a substantially identical polarization direction and at least one second polarizing layer portion having an orthogonal polarization direction, so as to selectively block and transmit therethrough radiation wavelengths. Such a mechanism can be designed to move both substrates to desired relative locations. Alternatively, the first substrate can remain stationary and the second substrate moved by the mechanism.

In a further aspect of the present invention, a method is provided that involves making a device as previously described and as described herein.

In yet another aspect of the present invention, a method of making an optical device is provided. The method comprises depositing a plurality of first polarizing stripes onto a first substrate so as to be substantially coplanar and adjacent one another along adjoining edges, with any two adjacent first polarizing stripes having orthogonal polarizations. The method can include depositing a plurality of second polarizing stripes onto a second substrate so as to be substantially coplanar and adjacent one another along adjoining edges, with any two adjacent second polarizing stripes having orthogonal polarizations. The first and second substrates are movable relative to one another such that each of the first polarizing stripes can completely or at least substantially overlap at least one second polarizing stripe having a substantially identical polarization and at least one second polarizing stripe having an orthogonal polarization. In this way, radiation wavelengths can be selectively blocked or allowed to transmit through the device.

Each of the plurality of polarizing stripes can be deposited on their respective substrate simultaneously. In addition, a shear coating process can be used to deposit corresponding polarizing material onto each substrate to form each polarizing stripe. Such shear coating can be is performed using any device capable of producing sufficient shear forces in the polarizing material during the coating process to produce the orthogonal polarizations between adjacent polarizing stripes. Such a device can include, for example, an extrusion die having a plurality of slot-shaped die openings corresponding to the plurality of substantially coplanar and adjacent polarizing stripes. Each of these die openings can be fed with a corresponding polarizing material by a plurality of reservoirs connected thereto. The device can also include a coating knife such as, for example, where polarizing material is simultaneously deposited from the reservoirs onto a substrate before being drawn under the coating knife and subjected to the desired degree of shear. Polarizing stripes that are shear coated onto a substrate either have a polarization parallel to or orthogonal to the coating direction, depending on the polarizing material used.

These and other advantages of the invention are more fully shown and described in the drawings and detailed description of this invention, where like reference numerals are used to represent similar parts. It is to be understood, however, that the drawings and description are for illustration purposes only and should not be read in a manner that would unduly limit the scope of this invention.

### BRIEF DESCRIPTION OF THE DRAWINGS

In the accompanying drawings:

FIGS. 1a and 1b are front plan views of two polarizing layers, according to the present invention, with polarizing stripes aligned so as to allow radiation to be transmitted therethrough, when superimposed one on top of the other as illustrated;

FIGS. 1c and 1d are front plan views of the two polarizing layers of FIGS. 1a and 1b, with their polarizing stripes aligned so as to block radiation from being transmitted therethrough, when superimposed one on top of the other as illustrated;

FIG. 2a is a top view of two polarizing substrates, according to the present invention, with polarizing layer portions aligned so as to allow radiation to be transmitted therethrough;

FIG. 2b is a top view of the two polarizing substrates of FIG. 2a, with their polarizing layer portions aligned so as to block radiation from being transmitted therethrough;

FIGS. 3a and 3b are front plan views of the two polarizing layers, according to the present invention, with curved polarizing stripes aligned so as to block radiation from being transmitted therethrough, when superimposed one on top of the other as illustrated; and

FIGS. 4a and 4b are front plan views of the two polarizing layers, according to the present invention, with checkered polarizing stripes aligned so as to block radiation from being transmitted therethrough, when superimposed one on top of the other as illustrated;

### DETAILED DESCRIPTION OF THE PREFERRED EMBODIMENTS

In describing preferred embodiments of the invention, specific terminology is used for the sake of clarity. The invention, however, is not intended to be limited to the specific terms so selected, and each term so selected includes all technical equivalents that operate similarly.

The specific exemplary embodiments disclosed herein are based on a fundamental property of some lyotropic liquid crystalline materials (e.g., various chromonics molecules) to act as a host matrix to orient certain light absorbing guest dyes, with the resulting combination functioning as light polarizers. In particular, when such a lyotropic liquid crystalline material is put into a solution containing such dyes and the solution shear coated onto a substrate, some dyes become oriented in a direction parallel to the coating direction and others dyes become oriented in a direction perpendicular to the coating direction, depending on the respective dye chemistries. This phenomenon has been used to produce two kinds of polarizers. One that has a light transmission direction oriented parallel to the coating direction and another that has a light transmission direction oriented perpendicular to the coating direction. A description of this phenomenon can be found, for example, in U.S. Pat. No. 6,245,399, which is incorporated herein by reference in its entirety. When a coating of one type of these solutions (e.g., with a parallel oriented transmission direction) is superposed over another coating of the other type of these solutions (i.e., with a perpendicularly oriented transmission direction) the transmission of the applicable light wavelengths through the coatings is blocked. When two coatings of the same type of these solutions are superposed, the applicable light wavelengths (which depends on the particular chemistries of the dyes used) can transmit through the coatings. The basic concept of the present invention is to coat each type of solution onto a substrate to form a coated layer having alternating portions of each type of these solutions. Two such coated substrates can then be superposed with their respective layer portions aligned to either block the transmission of the applicable light wavelengths, when opposite solution types are superposed, or allow the transmission of the applicable light wavelengths, when the same solution types are superposed.

In particular, the present invention includes a first layer comprising at least one first layer portion adjacent at least one second layer portion. The first layer portion comprises a first guest host polarizer and the second layer portion comprising a second guest host polarizer. The first guest host polarizer comprises a first host matrix, and at least one or more first guest dyes disposed in the first host matrix and oriented so as to absorb a first band or range of radiation wavelengths (e.g., the band of visible light, red light, blue light, or some other color of light) having a first polarization state. In addition, the second guest host polarizer comprises a second host matrix and at least one or more second guest dyes disposed in the second host matrix and oriented to absorb a second band or range of radiation wavelengths (e.g., the band of visible light, red light, blue light, or some other color of light) having a second polarization state orthogonal to the first polarization state. Preferably, the first layer comprises a plurality of first and second layer portions disposed in an alternating manner along adjoining edges, with one first layer portion being disposed between any two adjacent second layer portions and one second layer portion being disposed between any two adjacent first layer portions. It is desirable for the first and second layer portions to be substantially coplanar for space efficiency considerations such as, for example, when the maintaining a minimized thickness for the device is desired.

To produce an optical device for selectively blocking (i.e., preventing the passage therethrough) and transmitting (i.e. allowing the passage therethrough) radiation having radiation wavelengths (e.g., visible light, infrared and ultraviolet radiation, etc.), a second layer is included that comprises at least one third layer portion adjacent at least one fourth layer portion. The third layer portion comprises a third guest host polarizer and the fourth layer portion comprises a fourth guest host polarizer. The third guest host polarizer comprises a third host matrix, and at least one or more third guest dyes disposed in the third host matrix and oriented so as to absorb a third band or range of radiation wavelengths (e.g., the band of visible light, red light, blue light, or some other color of light) having a third polarization state. In addition, the fourth guest host polarizer comprises a fourth host matrix and at least one or more fourth guest dyes disposed in the fourth host matrix and oriented to absorb a fourth band or range of radiation wavelengths (e.g., the band of visible light, red light, blue light, or some other color of light) having a fourth polarization state orthogonal to the third polarization state. The first layer and the second layer completely or at least substantially overlap one another and are preferably disposed substantially parallel to one another. In addition, at least one of the first layer and the second layer is moveable such that each layer portion of the first layer can completely or at least substantially overlap at least one third layer portion and at least one fourth layer portion of the second layer so as to selectively block and transmit radiation wavelengths.

It is preferable for the second layer to comprise a plurality of third and fourth layer portions disposed in an alternating manner along adjoining edges, with one third layer portion being disposed between any two adjacent fourth layer portions and one fourth layer portion being disposed between any two adjacent third layer portions. It is also desirable for the third and fourth layer portions to be substantially coplanar for space efficiency considerations such as, for example, when the maintaining a minimized thickness for the device is desired. As used herein, each the layer portion of the first layer is considered to substantially overlap either the layer portion of the second layer if the layer portions exhibiting orthogonal polarization states overlap enough to produce the desired selective blocking and transmitting of the radiation of interest (e.g., obtaining the required degree of opacity or radiation absorption, when a first and fourth layer portion overlap and/or when a second and third layer portion overlap.). Also as used herein, the first and second layers are considered to be substantially parallel to each other, when their spatial orientation still obtains (i.e., the number of degrees away from being parallel is not high enough to prevent) the desired selective blocking and transmitting of the radiation of interest.

Each host matrix can comprise a lyotropic liquid crystalline material. Lyotropic liquid crystalline materials can be used as the molecular or host matrix of guest-host polarizers. Particularly useful lyotropic materials include a class of such liquid crystalline compounds known as chromonics, especially those that have been oriented. Chromonics molecules that are particularly useful are those containing at least one triazine group. Useful guest dyes can include acid, basic, direct and reactive dyes. Various specific host matrices and guest dyes suitable for use according to the present invention can be found in U.S. Pat. No. 6,538,714, which is incorporated herein by reference in its entirety. It can be desirable for each host matrix to comprise a chromonics material that provides the same orientation. The at least one first guest dye and the at least one third guest dye can each be oriented to absorb the same band of radiation wavelengths having the same polarization state. In addition, the at least one second guest dye and the at least one fourth guest dye can each be oriented to absorb the same band of radiation wavelengths having the same polarization state.

If desired, for a particular application, guest dyes can be chosen such that each layer portion absorbs the same radiation wavelengths. Therefore, in one embodiment, the band of radiation wavelengths absorbed by the at least one first guest dye and the at least one third guest dye is the same or substantially the same as the band of radiation wavelengths absorbed by the at least one second guest dye and the at least one fourth guest dye. As used herein, two or more bands of radiation wavelengths are considered substantially the same, if the bands overlap enough to produce the desired optical effect (e.g., obtaining the required degree of opacity or radiation absorption, when a first and fourth layer portion overlap and/or when a second and third layer portion overlap.).

The at least one first guest dye, the at least one second guest dye, the at least one third guest dye and the at least one fourth guest dye can each be a plurality of guest dyes. In addition, the guest dyes of each layer portion can be chosen so as to completely or at least substantially absorb the band of visible light wavelengths. For example, when the object is to block all or substantially all visible light (i.e., to produce a black or close to black color), red, blue and yellow dyes can be used together for each guest dye. As used herein, each layer portion is considered to substantially absorb visible light, when the desired percentage of visible light absorption is achieved to within acceptable commercial tolerances for the particular application of the device. Thus, it can be desirable for the device to absorb at least about 60%, 70%, 80%, 90%, 95%, 96%, 97%, 98%, 99% or up to about 100% of the band of visible light wavelengths, when the first and fourth layer portions are disposed so as to overlap one another, and the second and third layer portions are disposed so as to overlap one another. For example, when the present invention is used in a welder's mask, a high degree of light opacity is required to protect the welder's eyes from the welding arc.

Some types of dyes produce polarizers having a transmission axis in the direction of coating, while other types of dyes produce polarizers having a transmission axis perpendicular to the direction of coating. The chromonics host molecule will orient the polarization direction of each guest dye molecule based on each guest dye molecule's chemistry. Therefore, in one embodiment, each guest dye in the first layer portion can have a different chemistry than each guest dye in the second layer portion, each guest dye in the third layer portion can have a different chemistry than each guest dye in the fourth layer portion, and each host matrix can comprises a chromonics material that orients the polarization direction of the at least one first guest dye and the at least one third guest dye so as to each be orthogonal to the polarization direction of the at least one second guest dye and the at least one fourth guest dye.

The first layer can comprise a plurality of first layer portions and a plurality of second layer portions disposed in alternating positions along adjoining edges, with one of the first layer portions being disposed between any two adjacent second layer portions and one of the second layer portions being disposed between any two adjacent first layer portions. In addition, the second layer can comprise a plurality of third layer portions and a plurality of fourth layer portions disposed in alternating positions along adjoining edges, with one of the third layer portions being disposed between any two adjacent fourth layer portions and one of the fourth layer portions being disposed between any two adjacent third layer portions. At least one of the first layer and the second layer is moveable such that, for example, each of the layer portions of the first layer can overlap at least one of the third layer portions and at least one of the fourth layer portions of the second layer.

The device can also comprise a first substrate and a second substrate. The first substrate can comprise a first surface coated with each first layer portion and each second layer portion, and the second substrate can comprise a second surface coated with each third layer portion and each fourth layer portion. It is desirable for each substrate to be at least transparent to the radiation wavelengths that are to be selectively blocked and transmitted (e.g., visible light). It can also be desirable for each substrate to be substantially transparent to any radiation. It can further be desirable for each substrate to be fully (i.e., about 100%) transparent to any radiation wavelengths.

The device can comprise a mechanism for moving at least one of the first substrate and the second substrate relative to one another such that each of the layer portions of the first layer can be disposed to overlap at least one third layer portion and at least one fourth layer portion of the second layer. Such a mechanism may include, for example, a manual or motor driven actuator attached to one or both of the substrates. For some applications, it may be desirable for one substrate to be so actuated and for the other substrate to remain stationary. For other applications, it may also be desirable for both substrates to be actuated by a mechanism, for example in opposite directions. Now the present invention will be further described referring to the figures.

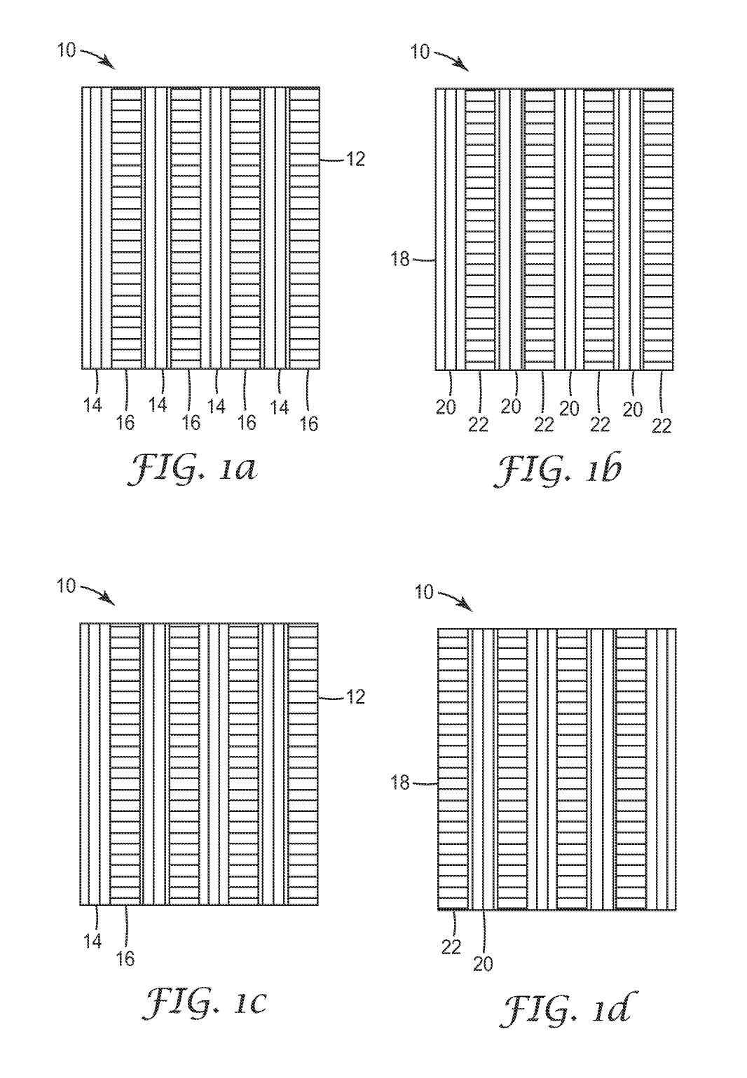

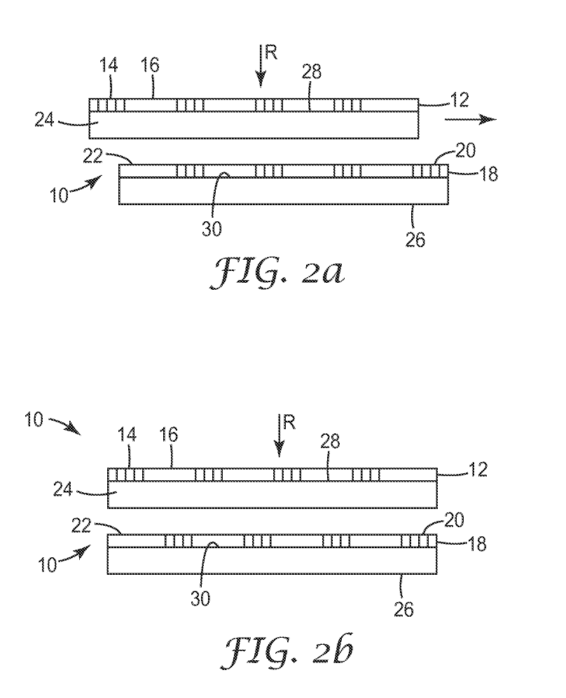

Referring to FIGS. 1a through 1d, a device 10 according to the present invention comprises one layer 12 having a plurality of adjacent and substantially coplanar polarizing layer portions 14 and 16, with any two adjacent ones of these polarizing layer portions 14 and 16 having orthogonal polarization directions. In order to selectively block and transmit radiation wavelengths traveling in a direction that will pass therethrough, as indicated by the arrow marked “R” in FIGS. 2a and 2b, the device 10 further comprises another layer 18 also having a plurality of adjacent and substantially coplanar polarizing layer portions 20 and 22, with any two adjacent of these other polarizing layer portions 20 and 22 having orthogonal polarization directions. The layer portions 14 and 20 have a radiation transmission axis in the direction of coating (as depicted in the figure with vertical lines), and the layer portions 16 and 22 have a radiation transmission axis perpendicular to the direction of coating (as depicted in the figure with horizontal lines).

These two layers 12 and 18 are movable relative to one another such that each of the polarizing layer portions 14 from layer 12 can be disposed so as to completely or at least substantially overlap (a) at least one of the polarizing layer portions 20 from the other layer 18 having a substantially identical polarization direction, and (b) at least one of the polarizing layer portions 22 from the other layer 18 having an orthogonal polarization direction. Such a positioning of the layers 12 and 18 will likewise dispose each of the polarizing layer portions 16 from layer 12 so as to completely or at least substantially overlap (a) at least one of the polarizing layer portions 22 from the other layer 18 having a substantially identical polarization direction, and (b) at least one of the polarizing layer portions 20 from the other layer 18 having an orthogonal polarization direction. When the layers 12 and 18 are positioned so that their respective layer portions of identical polarization are aligned, layer portions 14 and 20 and layer portions 16 and 22, then radiation wavelengths passing through the two layers 12 and 18 will transmit therethrough (see FIGS. 1a and 1b). In contrast, when the layers 12 and 18 are positioned so that their respective layer portions of orthogonal polarization are aligned, layer portions 14 and 22 and layer portions 16 and 20, then the transmission of the affected radiation wavelengths through the two layers 12 and 18 will be blocked (see FIGS. 1a and 1b). In this way, the device 10 can be made to selectively block and transmit radiation wavelengths passing therethrough simply by moving the two layers 12 and 18 relative to one another.

Referring to FIGS. 2a and 2b, it can be desirable for the device 10 to include a first substrate 24 and a second substrate 26. The first substrate 24 comprises a first surface 28 coated with the layer 12, and the second substrate 26 comprises a second surface 30 coated with the other layer 18. It is desirable for each substrate 24 and 26 to be at least transparent to the radiation wavelengths to be selectively blocked and transmitted (e.g., visible light). The direction of the radiation wavelengths passing through the device 10 is indicated by the arrow marked “R”. Each substrate can also be substantially transparent to any radiation. The device 10 includes a mechanism (not shown) for moving the first substrate 24 along the direction indicated by the arrow marked “D”, while the second substrate 26 remains stationary so as to selectively block and transmit therethrough radiation wavelengths “R”. In this way, the substrate 24 and 26 can be moved back and forth between a transmitting relationship (see FIG. 2a) and a blocking relationship (see FIG. 2b).

Such a mechanism can be designed to move both substrates 24 and 26 to desired relative locations. Alternatively, the first substrate 24 can remain stationary and the second substrate 26 moved by the mechanism. Such a mechanism may include, for example, a manual or motor driven actuator attached to one or both of the substrates 24 and 26. Whether only one substrate is actuated or both substrates are actuated can depend on the application for the device. For other applications, it may be desirable for both substrates to be actuated by a mechanism in opposite directions. Such substrates 24 and 26 to be moved by such a mechanism can comprise, for example, a pair of webs, plates and combinations thereof. As used herein, a web refers to a structure that is much wider and/or longer than it is thick. Such a web includes, for example, a belt, a film, a sheet, etc.

Each of the illustrated polarizing layer portions 14, 16, 18, 20 is in the form of a stripe. As used herein, a “stripe” refers to a layer having any width, length and peripheral shape that can be shear coated onto a surface, including those illustrated in FIGS. 1, 3 and 4. It can be desirable for the stripes to have about the same width. For example, it can be desirable for the width of each stripe is to be within the range of from about 50 micrometers to about 3 mm. Though, in some applications, it may be acceptable for the width to be greater than 3 mm. In addition, it is desirable for the width of the stripes to be less than 50 micrometers or as small as the stripe forming process permits. The smaller the width, the shorter the time it takes to move the layers relative to one another so as to either block (i.e. having stripes with orthogonal polarizers overlapping) or transmit (i.e., having stripes with parallel polarizers overlapping) the selected radiation (e.g., visible light, or a particular color of visible light).

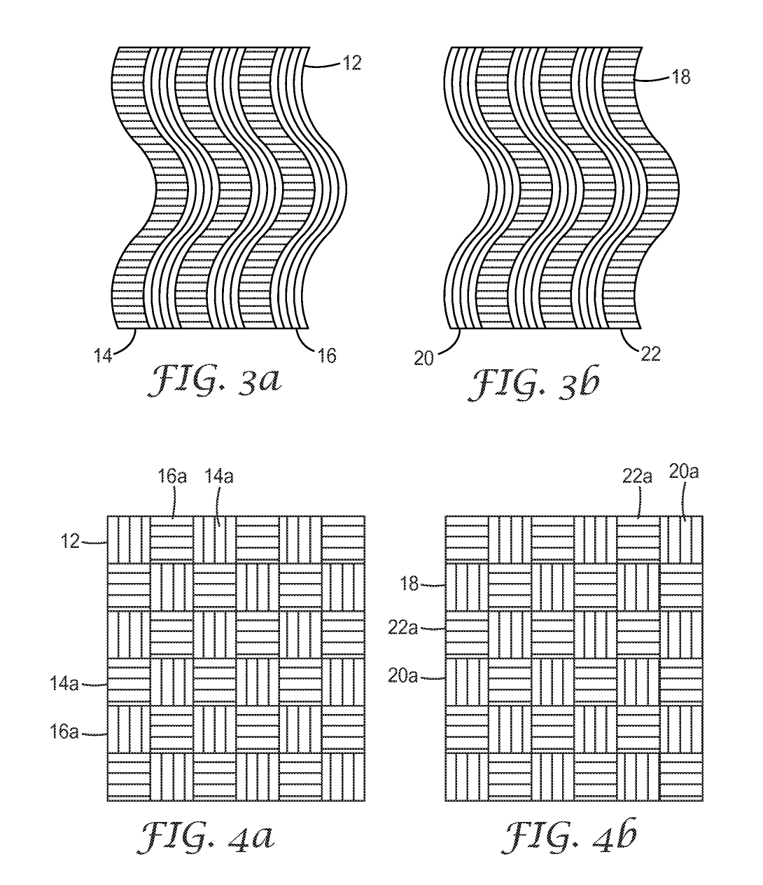

Referring to FIGS. 3a and 3b, one alternative embodiment of the layers 12 and 18 includes polarizing layer portions or stripes 14, 16, 20 and 22 that are curved or sinusoidal in shape. Referring to FIGS. 4a and 4b, another optional embodiment of the layers 12 and 18 includes polarizing layer portion segments 14a, 16a, 20a and 22a that are arranged in a checkered pattern. Such a pattern can be obtained, for example, by forming elongated stripes 14, 16, 20 and 22, like those shown in FIGS. 1a-1d, and cutting or otherwise segmenting the elongated stripes 14, 16, 20 and 22 into smaller lengths and then adhering the individual strip segments 14a, 16a, 20a and 22a to the corresponding substrate 12 or 18. It may be desirable to coat the elongated stripes 14, 16, 20 and 22 onto a reinforcing substrate (not shown) that is segmented and adhered onto the corresponding substrates 12 and 18 along with the stripe segments 14a, 16a, 20a and 22a.

As used herein, the term ‘color’ denotes a spectral distribution of less than the whole visible spectrum as is expected when one or more dyes are used to absorb light in one or more portions of the visible spectrum and to thereby transmit a color of light. Color can be understood in the context of the various dye-related arts. In this respect, transmitting a color of light means transmitting one or more wavelengths or wavelength bands of light in the visible spectrum, or in the case of black, substantially no wavelengths in the visible spectrum. The special case of black also includes dark shadings of gray where small amounts (e.g., no more than about 10% or 15%) of any or all visible wavelengths might be transmitted but still does not result in a dominant coloration.

Colored guest host polarizers useful in the present invention can be made in various ways. Colored polarizers exhibiting a wide range of spectral characteristics for either or both polarization states can be made that include a host matrix and at least two types of guest dyes in a single layer portion. In an exemplary embodiment, a colored polarizer of the present invention can include a molecular matrix that holds two or more types of dye molecules, at least one of the types being pleochroic dye molecules arranged in one or more predetermined orientations, so as to polarize incident light depending on color.

Molecular matrices can be used that orient different pleochroic dyes in different directions, depending on the chemical structure of the particular dye being oriented. Dichroic polarizing layer portions suitable for use as colored polarizers in the present invention can be formed by coating an aqueous solution of one or more pleochroic guest dyes and a lyotropic liquid crystal host material onto a solid substrate and drying the coating. Exemplary substrates include glass and rigid polymeric substrates as well as flexible polymer films, multilayer films, optical stacks, structured films or substrates, and the like.

Guest-host polarizers according to the present invention can exhibit surprisingly improved heat resistance, especially when applied to a glass substrate. Heat resistance can be important, especially for constructions that may be subjected to elevated temperature processing or for displays that might generate heat during operation.

In an exemplary embodiment, lyotropic liquid crystalline materials can be used as the molecular or host matrix of guest-host polarizers. Liquid crystalline matrix materials containing at least one triazine group can be especially useful. Matrix materials in this class can act as hosts to a variety of guest dyes while imparting the same or different orientations to different dyes. This can enable polarizing layer portions to be produced using suitable choices of dyes that allow transmission of different colors in different polarization planes.

When coating a liquid solution of the host compound with one or more suitable guest dyes, it is better to apply shear to each liquid layer portion to impart an ordered or oriented structure to the liquid crystalline host material. For sufficient applied shear, the oriented liquid crystalline structure can orient the pleochroic guest dye or dyes to produce oriented coated layer portions that can be dried to produce a single layer that has the desired polarizing properties. Because the levels of shear stress created in the liquid layer portions during coating are low compared to the shear stresses which might cause mechanical deformation of rigid substrates, the process of forming the layer portions has a reduced tendency to create stresses that might distort the optical properties of the substrate.

A particular type of guest dye can be used singly to produce dichroic effects over a limited range of wavelengths, or in combination with other guest dyes to produce dichroic effects over a wider range of wavelengths as might be useful, for example, in producing neutral density guest host polarizers or dual color guest host polarizers. The direction of orientation of the dyes is in general a function of the direction in which the coating is carried out. Some types of dyes produce guest host polarizers having a transmission axis in the direction of coating, while other types of dyes produce polarizers having a transmission axis perpendicular to the direction of coating.

Molecular matrix materials suitable for the present invention include lyotropic nematic liquid crystal host compounds of the type disclosed in U.S. Pat. No. 5,948,487 and in and co-assigned U.S. patent application Ser. No. 09/172,440, the disclosures of which are hereby incorporated by reference herein in their entirety. The structures of exemplary host compounds include the following structures, labeled Compound A and Compound B:

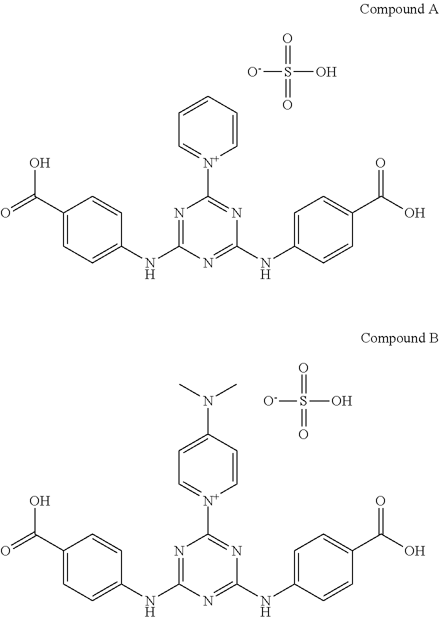

One class of dyes, when used with host compounds of the present invention in aqueous solution, can align themselves in relation to the host compounds in such a manner as to pass substantially all visible light polarized in a plane parallel to the direction of coating. These dyes are called parallel-colorless dyes. An exemplary class of guest dyes that behave in this manner are the triazine dyes, also commonly referred to as reactive dyes. Dyes that can align themselves in relation to the host compounds so as to pass substantially all visible light polarized in a plane perpendicular to the direction of coating are called perpendicular-colorless dyes. An exemplary class of dyes that behaves in this manner is the class known as direct dyes.

Guest-host coating solutions containing host and guest compounds as described herein can be prepared by first preparing an aqueous solution of water and a pH-adjusting compound such as NH4OH. The coating solution can then be prepared by dissolving the host compound and the guest compound, along with other additives such as surfactants to improve coatability, in the aqueous solution. Suitable water-soluble polymeric binders can also be added in small amounts to the host solutions in amounts ranging from less than 1% by weight to 5% or more. Polymers that have been found useful for this purpose include dextran-type polymers or their sulfates and sulfonated polystyrene. The host compound can typically be added in amounts sufficient to form a lyotropic solution having a host compound concentration of about 8% to 20% by weight of solution, though concentrations in the range of about 10% to 16% are often preferable. Host solution concentrations outside of this range can also be used provided that a desired level of functionality is maintained. For example, the resulting solution should provide sufficient ordering of the guest-host structure after coating to act as a polarizer, and the resulting coating solution should be sufficiently concentrated to provide adequate coating thickness and dryability, but not so concentrated as to be prohibitively difficult to coat and orient after coating.

If it is desired to polarize light in only a selected range of wavelengths, a single dye may be used in the guest-host solution. If it is desired to provide a neutral density polarizer, that is to say a polarizer which polarizes light in a substantially equal manner over the visible spectrum, several guest dyes of different colors, but similar orientations can be added to the host solution. Polarizers that are of substantially neutral density can, for example, be produced by adding similarly orienting cyan, magenta, and yellow dyes to the host solution, or, alternatively, by adding similarly orienting violet and yellow dyes to the host solution. Many other dye combinations are also possible. If it is desired to compose layer portions that transmit one color of light of one polarization and another color of light (or no visible light) of another polarization, two or more guest dyes can be used, at least two of which orient differently upon coating. For the purposes of this disclosure, non-orienting dyes and dyes that orient in a particular direction upon coating or shearing are to be considered differently orienting dyes.

Coating of the guest-host solution onto solid substrates can be performed by any convenient means, though coating methods which impart a sufficient orienting shear stress to the coated layer during coating are preferred. Shear stress imparted to the coated layer during coating can serve to urge molecular ordering of the guest and host molecules. Coating techniques that can impart shear stresses range from using wire-wound coating rods to conventional extrusion dyes.

Drying of the coated layer can be performed by any means suitable for drying aqueous coatings which does not damage the coating or significantly disrupt any molecular ordering of the coated layer which may have been produced by shear stress or other ordering effects applied during coating.

Substrates used for coating and/or patterning guest-host polarizers can include a wide variety of suitable substrates. For example, substrates can include glass or plastic substrates that are transparent or partially transparent, that are colored or clear, that are birefringent or non-birefringent, that include additional optically active layers or not, that include active or passive electronic devices or not, or that include any other layers or materials, whether integral with or added to the substrates, especially those that can be used to affect or control the transmission, reflection, or absorption of light through an overall display construction.

### Exemplary Embodiments

1. A device for selectively blocking and transmitting radiation having radiation wavelengths, the device comprising:

a first layer comprising at least one first layer portion adjacent at least one second layer portion, the first layer portion comprising a first guest host polarizer and the second layer portion comprising a second guest host polarizer, with the first guest host polarizer comprising:
a first host matrix, and at least one first guest dye disposed in the first host matrix and oriented so as to absorb a first band of radiation wavelengths having a first polarization state, and
   the second guest host polarizer comprising:
a second host matrix and at least one second guest dye disposed in the second host matrix and oriented to absorb a second band of radiation wavelengths having a second polarization state orthogonal to the first polarization state.
   2. The device according to embodiment 1, further comprising:

a second layer comprising at least one third layer portion adjacent at least one fourth layer portion, the third layer portion comprising a third guest host polarizer and the fourth layer portion comprising a fourth guest host polarizer, with the third guest host polarizer comprising:
a third host matrix, and at least one third guest dye disposed in the third host matrix and oriented so as to absorb a third band of radiation wavelengths having a third polarization state, and
   the fourth guest host polarizer comprising:
a fourth host matrix and at least one fourth guest dye disposed in the fourth host matrix and oriented to absorb a fourth band of radiation wavelengths having a fourth polarization state orthogonal to the third polarization state,

wherein the first layer and the second layer substantially overlap one another, and at least one of the first layer and the second layer is moveable such that each layer portion of the first layer can substantially overlap at least one third layer portion and at least one fourth layer portion of the second layer so as to selectively block and transmit radiation wavelengths.

3. The device according to embodiment 2, wherein each the host matrix comprises a lyotropic liquid crystalline material.
4. The device according to embodiment 2 or 3, wherein each the host matrix comprises a chromonics material providing the same orientation.
5. The device according to any one of embodiments 2 to 4, wherein the at least one first guest dye and the at least one third guest dye are each oriented to absorb the same band of radiation wavelengths having the same polarization state, and the at least one second guest dye and the at least one fourth guest dye are each oriented to absorb the same band of radiation wavelengths having the same polarization state.
6. The device according to embodiment 5, wherein the band of radiation wavelengths absorbed by the at least one first guest dye and the at least one third guest dye is substantially the same as the band of radiation wavelengths absorbed by the at least one second guest dye and the at least one fourth guest dye.
7. The device according to any one of embodiments 2 to 6, wherein the at least one first guest dye, the at least one second guest dye, the at least one third guest dye and the at least one fourth guest dye are each a plurality of guest dyes.
8. The device according to embodiment 7, wherein the guest dyes of each the layer portion substantially absorb the band of visible light wavelengths.
9. The device according to embodiment 8, wherein the device absorbs at least about 60% of the band of visible light wavelengths, when said first and fourth layer portions are disposed so as to overlap one another, and said second and third layer portions are disposed so as to overlap one another.
10. The device according to any one of embodiments 2 to 9, wherein each guest dye in the first layer portion has a different chemistry than each guest dye in the second layer portion, each guest dye in the third layer portion has a different chemistry than each guest dye in the fourth layer portion, and each the host matrix comprises a chromonics material that orients the polarization direction of the at least one first guest dye and the at least one third guest dye so as to each be orthogonal to the polarization direction of the at least one second guest dye and the at least one fourth guest dye.
11. The device according to any one of embodiments 2 to 10, wherein the first layer comprises a plurality of first layer portions and a plurality of second layer portions disposed in alternating positions along adjoining edges, with one of the first layer portions being disposed between any two adjacent second layer portions and one of the second layer portions being disposed between any two adjacent first layer portions, and the second layer comprises a plurality of third layer portions and a plurality of fourth layer portions disposed in alternating positions along adjoining edges, with one of the third layer portions being disposed between any two adjacent fourth layer portions and one of the fourth layer portions being disposed between any two adjacent third layer portions.
12. The device according to any one of embodiments 2 to 11, wherein at least one of the first layer and the second layer is moveable such that each of the layer portions of the first layer can overlap at least one of the third layer portions and at least one of the fourth layer portions of the second layer.
13. The device according to any one of embodiments 2 to 10, further comprising a first substrate and a second substrate, the first substrate comprising a first surface coated with each first layer portion and each second layer portion, and the second substrate comprising a second surface coated with each third layer portion and each fourth layer portion.
14. The device according to embodiment 13, further comprising a mechanism for moving at least one of said first substrate and said second substrate relative to one another such that each of said layer portions of said first layer can be disposed to overlap at least one third layer portion and at least one fourth layer portion of the second layer.
15. An optical device for selectively blocking and transmitting radiation having radiation wavelengths, the device comprising:

a first substrate coated with at least one first polarizing stripe and at least one second polarizing stripe, each the polarizing stripe comprising at least one layer of polarizing material, each the first polarizing stripe being disposed adjacent at least one second polarizing stripe, the first polarizing stripe blocking radiation wavelengths having a first polarization state, and the second polarizing stripe blocking radiation wavelengths have a second polarization state, with the first polarization state being orthogonal to the second polarization state.

16. The optical device according to embodiment 15, further comprising:

a second substrate coated with at least one third polarizing stripe and at least one fourth polarizing stripe, each the third polarizing stripe being disposed adjacent at least one fourth polarizing stripe, the third polarizing stripe blocking radiation wavelengths having the first polarization state, and the fourth polarizing stripe blocking radiation wavelengths have the second polarization state,

wherein the first substrate and the second substrate substantially overlap one another, and at least one of the first substrate and the second substrate is moveable such that each the polarizing stripe of the first substrate can substantially overlap at least one third polarizing stripe and at least one fourth polarizing stripe of the second substrate so as to selectively block and transmit radiation wavelengths.

17. The optical device according to embodiment 16, wherein the first substrate comprises a plurality of first polarizing stripes and a plurality of second polarizing stripes disposed in alternating positions along adjoining edges, with one of the first polarizing stripes being disposed between any two adjacent second polarizing stripes and one of the second polarizing stripes being disposed between any two adjacent first polarizing stripes, and the second substrate comprises a plurality of third polarizing stripes and a plurality of fourth polarizing stripes disposed in alternating positions along adjoining edges, with one of the third polarizing stripes being disposed between any two adjacent fourth polarizing stripes and one of the fourth polarizing stripes being disposed between any two adjacent third polarizing stripes.
18. The optical device according to embodiment 16 or 17, wherein each the polarizing stripe blocks substantially the same radiation wavelengths.
19. The optical device according to any one of embodiments 16 to 18, wherein each the first polarizing stripe and each the third polarizing stripe comprise the same polarizing material, and each the second polarizing stripe and each the fourth polarizing stripe comprise the same polarizing material.
20. The optical device according to any one of embodiments 16 to 19, further comprising:

a mechanism for moving at least one of the first substrate and the second substrate relative to one another such that each of the polarizing stripes of the first substrate can be disposed to overlap at least one third polarizing stripe and at least one fourth polarizing stripe of the second substrate.

21. An optical device comprising;

a first layer comprising a plurality of adjacent and substantially coplanar first polarizing layer portions, with any two adjacent first polarizing layer portions having orthogonal polarization directions.

22. The optical device according to embodiment 21, further comprising:

a second layer comprising a plurality of adjacent and substantially coplanar second polarizing layer portions, with any two adjacent second polarizing layer portions having orthogonal polarization directions,

wherein the first and second layers are movable relative to one another such that each of the first polarizing layer portions can substantially overlap at least one second polarizing layer portion having a substantially identical polarization direction and at least one second polarizing layer portion having an orthogonal polarization direction, so as to selectively block and transmit therethrough radiation wavelengths.

23. The device according to embodiment 22, further comprising a first substrate and a second substrate, the first substrate comprising a first surface coated with the first layer, and the second substrate comprising a second surface coated with the second layer.
24. The device according to embodiment 23, further comprising a mechanism for moving at least one of the first substrate and the second substrate relative to one another such that each of the first polarizing layer portions can substantially overlap at least one second polarizing layer portion having a substantially identical polarization direction and at least one second polarizing layer portion having an orthogonal polarization direction, so as to selectively block and transmit therethrough radiation wavelengths.
25. The device according to embodiment 23 or 24, wherein each substrate to be moved by the mechanism comprises a web.
26. The device according to any one of embodiments 23 to 25, wherein the first substrate remains stationary, and the second substrate is moved by the mechanism.
27. The optical device according to embodiment 21 or 26, wherein each the polarizing layer portion is in the form of a stripe.
28. The device according to embodiment 27, wherein each stripe has about the same width.
29. The device according to embodiment 27 or 28, wherein the width of each stripe is within the range of from about 50 micrometers to about 3 mm.
30. A method of making an optical device comprising:

depositing a plurality of first polarizing stripes onto a first substrate so as to be substantially coplanar and adjacent one another along adjoining edges, with any two adjacent first polarizing stripes having orthogonal polarizations.

31. The method according to embodiment 30, further comprising:

depositing a plurality of second polarizing stripes onto a second substrate so as to be substantially coplanar and adjacent one another along adjoining edges, with any two adjacent second polarizing stripes having orthogonal polarizations,

wherein the first and second substrates are movable relative to one another such that each of the first polarizing stripes can substantially overlap at least one second polarizing stripe having a substantially identical polarization and at least one second polarizing stripe having an orthogonal polarization, so as to selectively block and transmit therethrough radiation wavelengths.

32, The method according to embodiment 30 or 31, wherein each plurality of polarizing stripes are deposited on their respective substrate simultaneously.
33. The method according to any one of embodiments 30 to 32, wherein the depositing comprises shear coating corresponding polarizing material onto each substrate to form each polarizing stripe.

The following Examples of guest-host polarizer solutions have been selected merely to further illustrate features, advantages, and other details of the invention. It is to be expressly understood, however, that while these Examples serve this purpose, the particular ingredients and amounts used as well as other conditions and details are not to be construed in a manner that would unduly limit the scope of this invention.

### Example 1

In accordance with the above teachings and those of previously incorporated U.S. Pat. No. 6,538,714, an examplary guest host polarizer having light transmission parallel to the coating direction was prepared by mixing together the following ingredients: 8 grams of water, 0.25 grams of 30% ammonium hydroxide solution (from the Aldrich Company), 0.25 grams of the guest dye Direct Red 79 (formally available from Crompton & Knowles Colors, Inc., Charlotte, N.C., but now commercially available from Sensient Corporation, which purchased Crompton & Knowles Colors, Inc.), 0.25 grams of the guest dye Direct Blue 199 (commercially available from Sensient Corporation, and formerly Crompton & Knowles Colors, Inc.), 0.25 grams of the guest dye Reactive Yellow 27 (Golden Yellow EG150 from Keystone Corp.), 1.00 grams of the chromonics host matrix Compound B described above, and 0.06 grams of a 10% water solution of the surfactant triton X-100 to improve wetting of the solution onto a desired substrate.

### Example 2

An examplary guest host polarizer having light transmission perpendicular to the coating direction was prepared by mixing together the following ingredients: 8 grams of water, 0.25 grams of 30% ammonium hydroxide solution (from the Aldrich Company), 0.25 grams of the guest dye Direct Orange 102 (from Sensient Corporation), 0.25 grams of the guest dye Direct Blue 75 (Sensient Corporation), 0.25 grams of the guest dye Direct Yellow 86 (Sensient Corporation), 1.00 grams of the chromonics host matrix Compound B described above, and 0.06 grams of a 10% water solution of the surfactant triton X-100 to improve wetting of the solution onto a desired substrate.

The use of the Example 1 and 2 guest-host polarizer solutions to coat layer portions in accordance with the present invention, will result in a black or near black color (i.e., blocking of most visible light) when layer portions made from these two solutions are superposed over each other.

This invention may take on various modifications and alterations without departing from its spirit and scope. Accordingly, this invention is not limited to the above-described but is to be controlled by the limitations set forth in the following embodiments and any equivalents thereof.

This invention may be suitably practiced in the absence of any element not specifically disclosed herein.

All patents and patent applications cited above, including those in the Background section, are incorporated by reference into this document in total.

What is claimed is:

1. A device for selectively blocking and transmitting radiation having radiation wavelengths, said device comprising:
a first layer comprising at least one first layer portion adjacent at least one second layer portion, said first layer portion comprising a first guest host polarizer and said second layer portion comprising a second guest host polarizer, with said first guest host polarizer comprising:
a first host matrix, and at least one first guest dye disposed in said first host matrix and oriented so as to absorb a first band of radiation wavelengths having a first polarization state, and
said second guest host polarizer comprising:
a second host matrix and at least one second guest dye disposed in said second host matrix and oriented to absorb a second band of radiation wavelengths having a second polarization state orthogonal to the first polarization state.

2. The device according to claim 1, further comprising:
a second layer comprising at least one third layer portion adjacent at least one fourth layer portion, said third layer portion comprising a third guest host polarizer and said fourth layer portion comprising a fourth guest host polarizer, with said third guest host polarizer comprising:
a third host matrix, and at least one third guest dye disposed in said third host matrix and oriented so as to absorb a third band of radiation wavelengths having a third polarization state, and
said fourth guest host polarizer comprising:
a fourth host matrix and at least one fourth guest dye disposed in said fourth host matrix and oriented to absorb a fourth band of radiation wavelengths having a fourth polarization state orthogonal to the third polarization state,
wherein said first layer and said second layer substantially overlap one another, and at least one of said first layer and said second layer is moveable such that each layer portion of said first layer can substantially overlap at least one third layer portion and at least one fourth layer portion of said second layer so as to selectively block and transmit radiation wavelengths.

3. The device according to claim 2, wherein said at least one first guest dye and said at least one third guest dye are each oriented to absorb the same band of radiation wavelengths having the same polarization state, and said at least one second guest dye and said at least one fourth guest dye are each oriented to absorb the same band of radiation wavelengths having the same polarization state.

4. The device according to any one of claims 2 to 9, wherein each guest dye in said first layer portion has a different chemistry than each guest dye in said second layer portion, each guest dye in said third layer portion has a different chemistry than each guest dye in said fourth layer portion, and each said host matrix comprises a chromonics material that orients the polarization direction of said at least one first guest dye and said at least one third guest dye so as to each be orthogonal to the polarization direction of said at least one second guest dye and said at least one fourth guest dye.

5. An optical device for selectively blocking and transmitting radiation having radiation wavelengths, said device comprising:
a first substrate coated with at least one first polarizing stripe and at least one second polarizing stripe, each said polarizing stripe comprising at least one layer of polarizing material, each said first polarizing stripe being disposed adjacent at least one second polarizing stripe, said first polarizing stripe blocking radiation wavelengths having a first polarization state, and said second polarizing stripe blocking radiation wavelengths have a second polarization state, with the first polarization state being orthogonal to the second polarization state.

6. The optical device according to claim 5, further comprising:
a second substrate coated with at least one third polarizing stripe and at least one fourth polarizing stripe, each said third polarizing stripe being disposed adjacent at least one fourth polarizing stripe, said third polarizing stripe blocking radiation wavelengths having the first polarization state, and said fourth polarizing stripe blocking radiation wavelengths have the second polarization state,
wherein said first substrate and said second substrate substantially overlap one another, and at least one of said first substrate and said second substrate is moveable such that each said polarizing stripe of said first substrate can substantially overlap at least one third polarizing stripe and at least one fourth polarizing stripe of said second substrate so as to selectively block and transmit radiation wavelengths.

7. An optical device comprising;
a first layer comprising a plurality of adjacent and substantially coplanar first polarizing layer portions, with any two adjacent first polarizing layer portions having orthogonal polarization directions.

8. The optical device according to claim 7, further comprising:
a second layer comprising a plurality of adjacent and substantially coplanar second polarizing layer portions, with any two adjacent second polarizing layer portions having orthogonal polarization directions,
wherein said first and second layers are movable relative to one another such that each of said first polarizing layer portions can substantially overlap at least one second polarizing layer portion having a substantially identical polarization direction and at least one second polarizing layer portion having an orthogonal polarization direction, so as to selectively block and transmit therethrough radiation wavelengths.

9. A method of making an optical device comprising:
depositing a plurality of first polarizing stripes onto a first substrate so as to be substantially coplanar and adjacent one another along adjoining edges, with any two adjacent first polarizing stripes having orthogonal polarizations.

10. The method according to claim 9, further comprising:
depositing a plurality of second polarizing stripes onto a second substrate so as to be substantially coplanar and adjacent one another along adjoining edges, with any two adjacent second polarizing stripes having orthogonal polarizations,
wherein said first and second substrates are movable relative to one another such that each of said first polarizing stripes can substantially overlap at least one second polarizing stripe having a substantially identical polarization and at least one second polarizing stripe having an orthogonal polarization, so as to selectively block and transmit therethrough radiation wavelengths.
